(19) United States
(12) Patent Application Publication
(10) Pub. No.: US 2024/0013147 A1
(43) Pub. Date: Jan. 11, 2024

(54) APPARATUS, RE-ORDERING SYSTEM AND METHOD FOR MONITORING INVENTORY LEVELS

(71) Applicant: FERROMETAL OY, Nurmijärvi (FI)

(72) Inventor: Mika BRANDT, Nurmijärvi (FI)

(73) Assignee: FERROMETAL OY, Nurmijärvi (FI)

(21) Appl. No.: 18/253,486

(22) PCT Filed: Nov. 23, 2021
(86) PCT No.: PCT/FI2021/050801

§ 371 Date: May 18, 2023

(30) Foreign Application Priority Data
Nov. 23, 2020 (FI) 20206187

(51) Int. Cl. G06Q 10/087; G01S 7/4865

(52) U.S. Cl. CPC G06Q 10/087; G01S 7/4865

(57) ABSTRACT

An apparatus, reordering system and method for monitoring inventory of a storage unit. The apparatus (A) having a ToF sensor module (TS) for detecting distances to stored objects (SO). The apparatus is further provided with one or more reference distances (RF) whereby the apparatus examines the detected distances in relation to them. The reference distance can be adjusted remotely via a user interface (UI). The reordering system (RS) implements the disclosed apparatus and is configured to generate a refill order (RO) in the system for replenishing the storage unit (SU) when a set order point (OP) is exceeded.

### BACKGROUND OF THE INVENTION

The invention relates to an apparatus for monitoring inventory level of a storage unit remotely.

The invention further relates to a re-ordering system and to a method for monitoring inventory level of a storage unit.

The field of the invention is defined more specifically in the preambles of the independent claims.

Different types of storage units are widely used for storing mechanical components for example in assembly lines wherein industrial products are manufactured. It is essential that storage levels i.e. inventory levels of the storage units do not drop to zero since otherwise the operation needs to be stopped. On the other hand, high level of inventory means increased tied-up capital causing high capital costs. Therefore, automated reordering systems are developed for detecting when the amount of the components being stored in the units diminishes. When the amount of product in the storage space has dropped below a predetermined limit, it is then possible to send a refill order for a reordering system. Some solutions have been disclosed in documents JP-2020139938-A and US-2020164500-A1. The known solutions for detecting the inventory levels have shown to contain some disadvantages regarding their accuracy and user friendliness, for example.

### BRIEF DESCRIPTION OF THE INVENTION

An object of the invention is to provide a novel and improved solution for detecting degree of filling of a storage unit comprising physical objects.

The apparatus according to the invention is characterized by the characterizing features of the first independent apparatus claim.

The re-ordering system according to the invention is characterized by the characterizing features of the second independent apparatus claim.

The method according to the invention is characterized by the characterizing features of the independent method claim.

An idea of the disclosed solution is that the apparatus is intended for monitoring inventory level of a storage unit. The apparatus comprises at least one Time of Flight sensor module i.e. ToF sensor module for sensing the inventory level of the storage unit. The apparatus comprises one or more data communication devices for allowing communication between the ToF module, an electrical inventory system and a user interface. The ToF sensor module comprises an emitter for sending light signals towards stored objects of the storage unit and a receiver for receiving reflected signals. The apparatus further comprises at least one control unit for calculating distance between the ToF sensor module and the stored objects in response to detected trayelling time between the sent signal and the returning signal reflected from the surfaces of the stored objects. The apparatus is also provided with one or more reference distances magnitudes of which are inside a detection range of the ToF sensor module. Further magnitude of the reference distance can be adjusted remotely via a user interface communicating with the apparatus. The apparatus examines the calculated distances in relation to the input reference distance.

An advantage of the disclosed solution is that the sensing is reliable and accurate since it is based on received reflected sensing signals of the ToF sensor module. The sensing is not affected by the color of the components and disclosed system can detect objects even in poor lightning situations.

Furthermore, the disclosed ToF sensor module is easy to implement and mounting of the apparatus to the storage units is easy. The solution may also be retrofitted to the existing storage units and ordering systems.

A further advantage of the disclosed solution is that apparatus can be easily adapted to different situations and needs since the reference distance is easy and quick to update remotely through the user interface. An operator can adjust the apparatus to match with different storage units and monitoring needs in a simple manner utilizing a smart phone, personal computer or any other electrical terminal device.

According to an embodiment, the apparatus is calibrated to a zero point located at the remotely set reference distance whereby the monitored inventory level is examined in relation to the calibrated zero point. The calibration can be made to any point inside the storage unit, whereby the zero point is freely settable.

According to an embodiment, the reference distance is adjustable via the user interface to correspond maximum distance of a totally empty storage unit. Then the apparatus is configured to calibrate a zero point at the set maximum distance of the empty storage unit whereby the received sensing data is examined in relation to the calibrated zero point. In this embodiment, the zero point may be located at a furthest part of the storage unit, for example at a rear edge of a storage shelf or space.

According to an embodiment, the reference distance is adjustable via the user interface to correspond maximum distance of a full storage unit. Then the apparatus is configured to calibrate a zero point at the set maximum distance of the full storage unit whereby the received sensing data is examined in relation to the calibrated zero point. In this embodiment, the zero point may be located at a closest part of the storage unit, for example at a front edge of a storage shelf or space.

According to an embodiment, the apparatus is provided with data on dimensions of the stored objects in the direction of the detection signal. Then the apparatus is configured to calculate real-time number of the stored objects in the direction of the detection signal in the storage unit in response to the sensing data and the calibrated zero point. The apparatus may calculate how many objects is located between the zero point and the detected closest stored object.

According to an embodiment, the dimensions of the stored objects may be input and updated remotely by means of the user interface. This way the system may be updated if the dimensions of the stored objects change or if the stored objects are substituted by completely different objects. Thereby, the possibility for the remote updates increases operational flexibility of the apparatus.

According to an embodiment, the apparatus is provided with data on length of the storage unit in the direction of the detection signal and is configured to determine threshold distances for the monitored storage unit. The threshold distances can be for example a front and rear edge portion of a shelf or pallet. Then the apparatus is configured to monitor degree of fullness of the storage unit by comparing the sensed distances to the determined threshold distances of the storage unit.

According to an embodiment, the length of the storage unit may be input and updated remotely by means of the user interface.

According to an embodiment, the apparatus is configured to indicate for an operator the detected degrees of fullness in percentages in the user interface.

According to an embodiment, the reordering system is provided with a pre-determined order point relating to the degree of fullness and is configured to generate a refill order when the sensed degree of fullness is below the input order point.

According to an embodiment, the apparatus is provided with data on length of the storage unit in the direction of the detection signal and the apparatus is configured to determine threshold distances for the monitored storage unit. The apparatus is further provided with data on dimensions of the stored objects in the direction of the detection signal. Then the apparatus can calculate maximum number of the stored objects to be stored in the direction of the detection signal in the storage unit. Further, the apparatus calculates current number of the stored objects in the storage unit in relation to the calculated maximum number of the stored objects. Thereby, the apparatus may indicate for a user degree of fullness in percentages or by means of graphical patterns and characters, for example.

According to an embodiment, the apparatus is provided with initial data on number of the stored objects in the storage unit and dimensions of the objects at least in the direction of the detection signal. Then the apparatus can compare the sensed distance data and the input initial data and may calculate number of remaining objects in the storage unit.

According to an embodiment, the apparatus is configured to submit the monitoring results to the reordering system which is provided with an adjustable order point and is configured to generate a refill order when the detected number of remaining objects or the determined degree of fullness is below the order point.

According to an embodiment, the ToF sensor module is directed to monitor a monitoring line comprising several stored objects arranged consecutively and close to each other so that they form a row of individual physical objects.

According to an embodiment, the ToF sensor module is directed to monitor a monitoring line comprising several storage bins arranged consecutively and close to each other so that they form a row of storage bins. Each of the storage bins may comprise several mechanical components or individual objects. In this embodiment the store objects are thereby the storage bins.

According to an embodiment, the apparatus is provided with a sensing assembly comprising several parallel ToF sensor modules. Each sensor module is directed to detect dedicated monitoring line of the stored objects in the storage unit. In other words, the objects are arranged in lines one after each other and each line is provided with the ToF sensor module for monitoring the amount of the objects in the line. Thus, there may be several ToF sensor modules arranged in connection with a shelf, pallet or storage space. This embodiment may be implemented in situations where several similar or different stored objects are arranged in separate rows in the same storage unit.

According to an embodiment, the ToF sensor module is a separate piece mounted in a removable manner in connection with a shelf serving as the monitored storage unit. The ToF sensor module is configured to communicate with other electrical devices of the apparatus via a wireless data communication path. Thus, the ToF sensor module can be mounted to any kind of storage units and the mounting is easy and quick.

According to an embodiment, the storage unit is a shelf and is provided with several parallel ToF sensor modules which are arranged parallel with a front edge of the shelf. The ToF sensor modules may be arranged at a lateral distance from each other so that they all have dedicated sectors or lines to be monitored. An advantage of this embodiment is that the shelf may have several monitored rows of stored objects.

According to an embodiment, the ToF sensor module is a separate piece mounted in a removable manner in connection with a collar of a pallet whereby the pallet and the collar together form the monitored storage unit. The ToF sensor module may communicate with other electrical devices of the apparatus via a wireless data communication path.

According to an embodiment, the storage unit is a pallet, or a pallet provided with a collar. The pallet or the collar is provided with several parallel ToF sensor modules which are arranged parallel with one edge of the pallet or the collar. The ToF sensor modules may be arranged at a lateral distance from each other so that they all have dedicated sectors or lines to be monitored. An advantage of this embodiment is that the pallet may have several monitored rows of stored objects.

According to an embodiment, the storage unit is a flow rack implementing a FiFo principle (First in-First out) and comprises a slanting surface on which the objects move automatically due the gravity forwards so that always the oldest object is ready to be picked. The slanting surface may comprise freely rotating rollers facilitating the operation. The rack is provided with several parallel ToF sensor modules which are arranged parallel with one edge of the rack. The ToF sensor modules may be arranged at a lateral distance from each other so that they all have dedicated sectors or lines to be monitored. An advantage of this embodiment is that the rack may have several monitored rows of stored objects.

According to an embodiment, all the mentioned data input and updating measures can be executed via the Internet. Further, there may be a special computer application for providing one or more users and an administrator an access to the monitored inventory levels and to allow making amendments to the monitoring parameters.

According to an embodiment, the solution relates to a re-ordering system. The system comprises: at least one storage unit for storing mechanical objects; at least one apparatus provided with at least one contactless sensing device for sensing degree of filling of the storage unit; and wherein the re-ordering system is configured to send a refill order when an order point defining a set lower limit for the degree of filling is exceeded. Further, the mentioned apparatus is in accordance with the features disclosed in this document and is configured to provide the re-ordering system with the data on degree of filling of the storage unit. The re-ordering system may automatically monitor inventory level of the storage unit and may generate automatically re-ordering signals or messages to suppliers for replenishing the storage unit. As it is disclosed already above, input data and updates can be fed through an electronic user interface whereby controlling and maintenance measures are user-friendly.

According to an embodiment, the disclosed solution relates to method of monitoring inventory level of a storage unit. The method comprises: detecting the inventory level of the storage unit by means of at least one contactless sensing device; and communicating the sensing data via a data communication connection to an electrical inventory system for processing the sensing data. The method further comprises: monitoring the storage unit by means of at least one ToF sensor module and sending light signals towards the stored objects of the storage unit and receiving reflected signals; calculating distances between the ToF sensor module and the stored objects in response to detected travelling times between the sent signals and the reflected signals; examining the calculated distances in relation to at least one reference distance in the inventory system; and adjusting magnitude of the reference distance inside a detection range of the ToF sensor module remotely via a user interface of the inventory system.

According to an embodiment, the disclosed solution is suitable for monitoring the levels of independent raw material pieces, unfinished and finished goods, and components, physical pieces and devices.

According to an embodiment, the disclosed solution is applied in stock monitoring application in a warehouse.

According to an embodiment, the disclosed solution is applied in re-ordering application in a production plant, assembly line or service point, for example.

According to an embodiment, the generated sensing data is utilized for producing automated order triggering for the electrical re-ordering system.

According to an embodiment, the monitored storage unit is intended for storing a plurality of physical mechanical components. The components may be stored on shelves, storage bins, palettes, and racks for example. The ToF-sensor module is mounted to the storage unit or to a separate support structure arranged in proximity to the monitored storage unit.

According to an embodiment the apparatus is configured to compare the sensed measuring distance to a predetermined order point. The order point or reorder point defines a distance corresponding to the situation when the inventory level i.e. quantity of the stored objects inside the storage unit is such that new delivery of the components is received before the remaining components in the storage unit run out. In other words, when the sensed distance is greater than the set re-ordering distance, a reorder is triggered to the ordering system and the storage unit is replenished automatically.

According to an embodiment, the control unit of the apparatus comprises one or more processors for calculating the travelling time and corresponding distance in response to the received sensing data. The control unit may be located external to the ToF sensor module in connection with the inventory system or anywhere else. In some case there may a control unit arranged in connection with the ToF sensor module, whereby some or all calculations can be executed already there.

According to an embodiment, the control unit of the apparatus is configured to produce and calculate the distance data as disclosed in the embodiments above and is further configured to generate reorders. Then the system is provided with input reordering strategy, limit values, reference data or corresponding instructions for triggering the reorder. The triggered reorder may be transmitted via the wireless communication path to the ordering system or the inventory system. In this embodiment the apparatus not only produces remote sensing data and calculates distances but also generates independently the reorders for replenishing the storage unit.

The above disclosed embodiments may be combined in order to form suitable solutions having those of the above features that are needed.

### BRIEF DESCRIPTION OF THE FIGURES

Some embodiments are described in more detail in the accompanying drawings, in which

FIG. 1 is a schematic view of an apparatus for monitoring inventory level of a storage unit,

FIG. 2 is a schematic side view of an arrangement wherein a ToF sensor module is arranged to monitor a row of several storage bins on a shelf,

FIG. 3 is a schematic side view of an arrangement wherein a ToF sensor module is arranged to monitor a detection line comprising several individual vertically standing objects,

FIG. 4 is a schematic top view of an assembly comprising several parallel ToF sensor modules and their dedicated detecting lines, and

FIG. 5 is a schematic view of a pallet provided with Tof sensor modules mounted to a collar.

For the sake of clarity, the figures show some embodiments of the disclosed solution in a simplified manner. In the figures, like reference numerals identify like elements.

### DETAILED DESCRIPTION OF SOME EMBODIMENTS

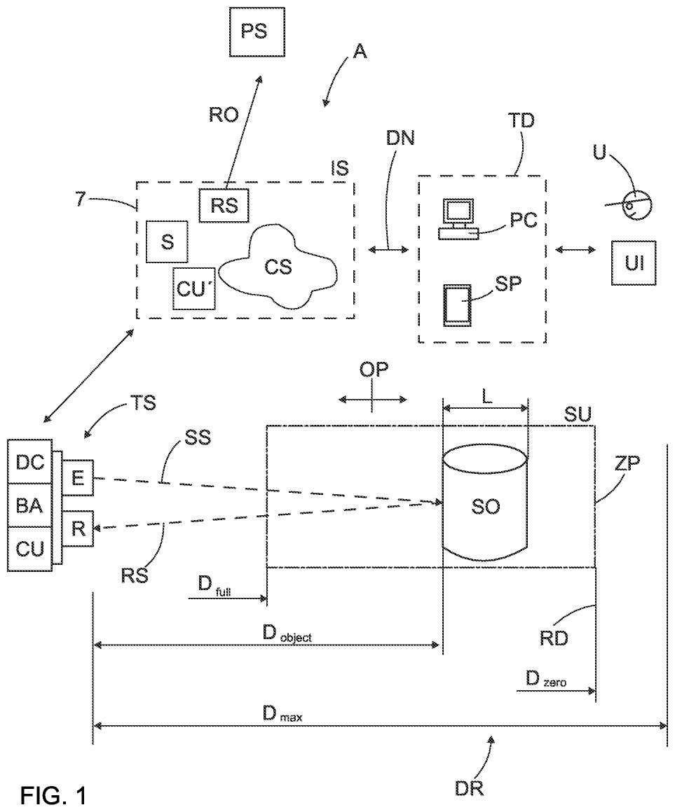

FIG. 1 discloses some basic features of an apparatus A. There is a storage unit SU wherein stored objects SO can be placed. Inventory level of the storage unit SU can be monitored by means of a ToF sensor module TS which is arranged to send a sensing signal SS from an emitter E and is configured to receive a reflecting signal RS by means of a receiver R. The sent sensing signal bounces from a surface of the stored object SO. The ToF sensor module TS is provided with a data communication device DC for transmitting the sensing data to an inventory system IS. The transmission may be wired or wireless. The ToF sensor module TS may comprise a control unit CU for processing the sensing data prior transmitting the data to the inventory system, or alternatively, raw sensing data may be sent and the data can be processed in the inventory system IS by means of a control unit CU′. The processing may be executed also in both control unit CU and CU′. The ToF sensor module TS may comprise a battery BA whereby it may be an independent device which is freely mountable.

The inventory system IS may comprise a cloud service CS or one or more servers S, and it may be located external to the storage unit SU. The inventory system IS may communicate with one or more electrical terminal devices such as personal computers PC and smart phones SP. The inventory system IS may comprise a re-ordering system RS which may send re-orders RO to product suppliers PS for replenishing the storage unit SU.

One or more users U and an administrator have access to the inventory system IS via a user interface UI of the terminal devices TD. Parameters and needed basic data can be input and updated in the user interface UI from anywhere. Monitored inventory levels can also be read from anywhere and simultaneously by several authorized users U. Communication between the user U and the inventory system IS may be executed in data networks DN such as in the Internet. Communication between the ToF sensor module TS and the inventory system IS may be based on IoT-technology, for example.

FIG. 1 further discloses that the ToF sensor module TS has a maximum detection distance Dₘₐₓ, which may be 4 meters, for example. In the present solution, detection range DR can be defined by setting threshold distances D_{zero} corresponding to an empty storage unit SU and D_{full} corresponding to a full storage unit SU. A reference distance RD may be defined to correspond to rear end portion of the storage unit SU, or alternatively, to a front edge of the storage unit SU. A zero point ZP can be defined at the reference distance RD. The reference distance RF can be input and adjusted by means of the user interface UI as well as other parameters. The reference distance RF attaches sensed distance D_{object} of the stored object to the storage unit SU and its dimensions. When the inventory system IS is provided with data on dimension L and dimensions of the storage unit in the direction of the detection signals, the inventory system IS can calculate maximum number and current number of stored objects SO in the storage unit SU. An order point OP may be set to correspond desired distance D_{object}, number or remaining stored objects SO or relative fullness of the storage unit SU. The order point OP can be updated via the user interface UI.

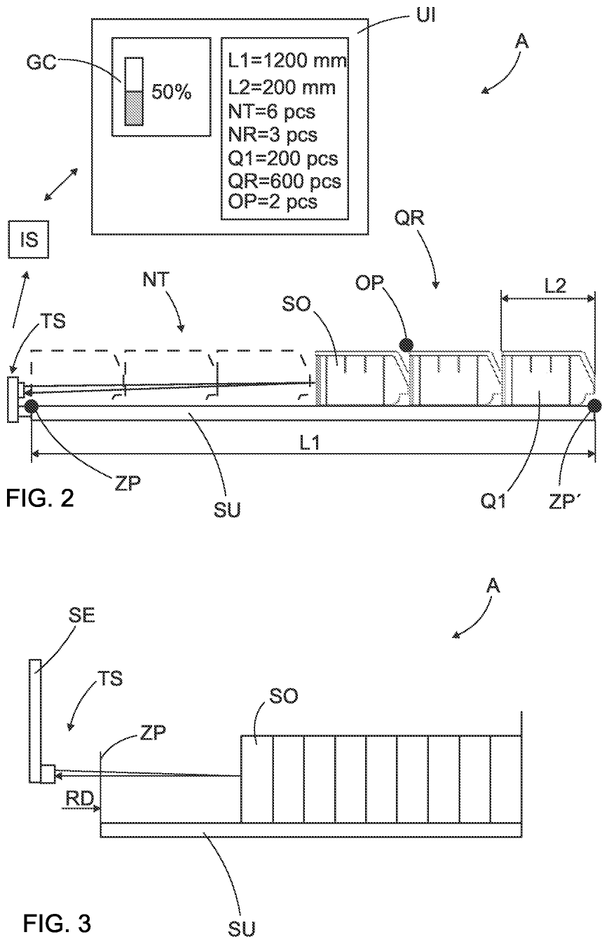

FIG. 2 discloses that a storage object SO may be a storage bin stored on a self which is serving as a storage unit SU. A ToF sensor module TS may be mounted to one edge of the self. A zero point ZP may be defined by a set reference distance to closest edge, or alternatively, another zero point ZP′ may be defined to an opposite edge. Dimension of the self L1 and dimensions L2 of the storage bins may be input to the inventory system IS by means of a user interface UI. Total number TN of storage bins can be calculated, and remaining number NR of bins may be detected and shown in the user interface UI. Each storage bin may comprise a set quantity Q1 of components whereby remaining total quantity QR can be calculated and shown in the user interface. An order point OP may be set to a desired number of storage bins, in this case 2 pieces. The user interface UI may also produce graphical characters GC and other visualizations regarding degree of filling.

FIG. 3 discloses a ToF sensor module TS arranged to monitor a row of several individual stored objects SO supported on a storage unit SU. The ToF sensor module TS may be supported by means of a support element SE at distance from the storage unit SU. The distance is known, and it can be bed to the inventory system as a reference distance. The distance measurement may be calculated to this zero point ZP and this is taken into consideration in the future distance measurements.

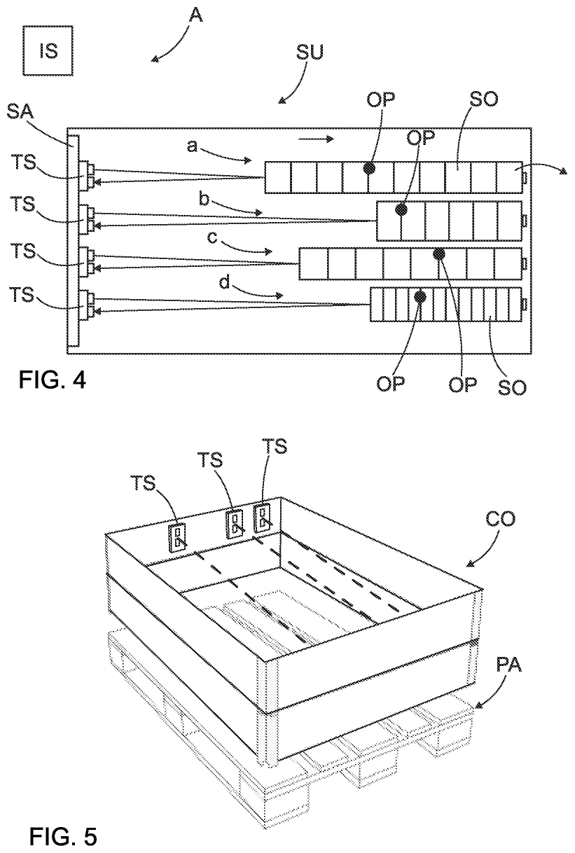

FIG. 4 discloses a storage unit SU which is a flow rack wherein store objects SO are flowing automatically towards an edge on a right side. There are several parallel monitoring lines a-d and each of them are provided with dedicated ToF sensor modules TS belonging to a sensor assembly SA. As can be noted, each line a-d may comprise different stored objects SO and may have individual order points OP.

FIG. 5 discloses a pallet P on which one or more collars CO may be mounted. The collar CO may be provided with one or more ToF sensor modules TS.

The drawings and the related description are only intended to illustrate the idea of the invention. In its details, the invention may vary within the scope of the claims.

1. An apparatus (A) for monitoring inventory level of a storage unit (SU), wherein the apparatus (A) comprises:
at least one contactless sensing device for sensing the inventory level of the storage unit (SU) by means of detection signals; and
at least one data communication device (DC) for allowing communication between electrical devices of the apparatus (a),
wherein
the mentioned at least one sensing device is a Time of Flight (ToF) sensor module (TS) comprising an emitter (E) for sending light signals (SS) towards stored objects (SO) of the storage unit (SU) and a receiver (R) for receiving reflected signals (RS);
the apparatus (A) comprises at least one control unit (CU, CU′) for calculating distances between the ToF sensor module (TS) and the stored objects (SO) in response to detected travelling time between the sent light signal and the returning signal reflected from the surfaces of the stored objects (SO);
the apparatus (A) is provided with at least one reference distance (RD) inside a detection range (DR) of the ToF sensor module (TS) and wherein magnitude of the reference distance (RD) is adjustable remotely via a user interface (UI); and
the apparatus (A) is configured to examine the calculated distances in relation to the reference distance (RD).

2. The apparatus as claimed in claim 1, wherein
the apparatus (A) is calibrated a zero point (ZP) located at the remotely set reference distance (RD) whereby the monitored inventory level is examined in relation to the calibrated zero point (ZP).

3. The apparatus as claimed in claim 1, wherein
the reference distance (RD) is adjustable via the user interface (UI) to correspond maximum distance of a totally empty storage unit (SU);
and wherein the apparatus (A) is configured to calibrate a zero point (ZP′) at the set maximum distance of the empty storage unit (SU) whereby the received sensing data is examined in relation to the calibrated zero point (ZP′).

4. The apparatus as claimed in claim 1, wherein
the reference distance (RD) is adjustable via the user interface (UI) to correspond maximum distance of a full storage unit (SU);
and wherein the apparatus (A) is configured to calibrate a zero point (ZP) at the set maximum distance of the full storage unit (SU) whereby the received sensing data is examined in relation to the calibrated zero point (ZP).

5. The apparatus as claimed in claim 3, wherein
the apparatus (A) is provided with data on dimensions (L2) of the stored objects (SO) in the direction of the detection signal; and
the apparatus (A) is configured to calculate real-time number of the stored objects (SO) in the direction of the detection signal in the storage unit (SU) in response to the sensing data and the calibrated zero point (ZP).

6. The apparatus as claimed in claim 1, wherein
the apparatus (A) is provided with data on length (L1) of the storage unit (SU) in the direction of the detection signal and is configured to determine threshold distances for the monitored storage unit (SU); and
the apparatus (A) is configured to monitor degree of fullness of the storage unit (SU) by comparing the sensed distances to the determined threshold distances of the storage unit (SU).

7. The apparatus as claimed in claim 1, wherein
the apparatus (A) is provided with data on length of the storage unit (L1) in the direction of the detection signal and is configured to determine threshold distances for the monitored storage unit (SU);
the apparatus (A) is further provided with data on dimensions of the stored objects (SO) in the direction of the detection signal;
the apparatus (A) is configured to calculate maximum number of the stored objects (SO) to be stored in the direction of the detection signal in the storage unit (SU); and
the apparatus (A) is configured to calculate current number of the stored objects (SO) in the storage unit (SU) in relation to the calculated maximum number of the stored objects (SO).

8. The apparatus as claimed in claim 1, wherein
the apparatus (A) is provided with initial data on number of the stored objects (SO) in the storage unit (SU) and dimensions (L2) of the objects (SO) at least in the direction of the detection signal;
and wherein the apparatus (A) is configured to calculate number of remaining objects in the storage unit (SU) in response to comparison of the sensed distance data and the input initial data.

9. The apparatus as claimed in claim 1, wherein
the apparatus (A) is configured to submit the monitoring results to the reordering system (RS) which is provided with an adjustable order point (OP) and is configured to generate a refill order (RO) when the detected number of remaining objects or the determined degree of fullness is below the order point (OP).

10. The apparatus as claimed in claim 1, wherein
the ToF sensor module (TS) is directed to monitor a monitoring line comprising several stored objects (SO) arranged consecutively and close to each other so that they form a row of individual physical objects.

11. The apparatus as claimed in claim 1, wherein
the apparatus (A) is provided with a sensing assembly (SA) comprising several parallel ToF sensor modules (TS) each of them directed to detect dedicated monitoring lines (a-d) of the stored objects (SO) in the storage unit (SU).

12. The apparatus as claimed in claim 1, wherein
the ToF sensor module (TS) is a separate piece mounted in a removable manner in connection with a shelf serving as the monitored storage unit (SU);
and wherein the ToF sensor module (TS) is configured to communicate with other electrical devices of the apparatus via a wireless data communication path.

13. The apparatus as claimed in any claim 1, wherein
the ToF sensor module (TS) is a separate piece mounted in a removable manner in connection with a collar (CO) of a pallet (PA) whereby the pallet (PA) and the collar (CO) together form the monitored storage unit (SU);
and wherein the ToF sensor module (TS) is configured to communicate with other electrical devices of the apparatus via a wireless data communication path.

14. A reordering system comprising:
at least one storage unit (SU) for storing mechanical objects,
and wherein the storage unit (SU) comprises at least one apparatus (A) provided with at least one contactless sensing device for sensing degree of filling of the storage unit (SU);
and wherein the reordering system (RS) is configured to send a refill order (RO) when an order point (OP) defining a set lower limit for the degree of filling is exceeded;
wherein
the mentioned apparatus (A) is in accordance with claim 1 and is configured to provide the reordering system (RS) with the data on degree of filling of the storage unit (SU).

15. A method for monitoring inventory level of a storage unit (SU), wherein the method comprises:
detecting the inventory level of the storage unit (SU) by means of at least one contactless sensing device; and
communicating the sensing data via a data communication connection to an electrical inventory system (IS) for processing the sensing data;
wherein
monitoring the storage unit (SU) by means of at least one ToF sensor module (TS) and sending light signals towards the stored objects (SO) of the storage unit (SU) and receiving reflected signals;
calculating distances between the ToF sensor module (TS) and the stored objects (SO) in response to detected travelling times between the sent light signals and the reflected signals;
examining the calculated distances in relation to at least one reference distance in the inventory system (IS); and
adjusting magnitude of the reference distance inside a detection range of the ToF sensor module (TS) remotely via a user interface (UI) of the inventory system (IS).
